(19) United States
(12) Patent Application Publication
(10) Pub. No.: US 2002/0039408 A1
(43) Pub. Date: Apr. 4, 2002

(54) Method and system for enabling workers to communicate anonymously with their employers

(75) Inventors: Christopher R. Hall, Philadelphia, PA (US); Joseph L. Welsh, Alexandria, VA (US)

Correspondence Address: MENDELSOHN AND ASSOCIATES PC, 1515 MARKET STREET, SUITE 715, PHILADELPHIA, PA, 19102, US

(73) Assignee: SecureTell, Inc., Philadelphia, PA (US)

(21) Appl. No.: 09/911,041

(22) Filed: Jul. 23, 2001

Related U.S. Application Data
(60) Provisional application No. 60/237,447, filed on Oct. 3, 2000.

(51) Int. Cl. G06F 17/60; G10L 21/00

(52) U.S. Cl. 379/90.01; 704/270.1

(57) ABSTRACT

Workers access the system, for example, by telephone, web browser, e-mail, or fax, without the assistance of a human intermediary, such as an operator. The system deploys parsing and sorting routines to ascertain the nature of a communication, determine how to handle the communication, and select a roster of representatives qualified to handle the communication. The system determines whether to connect telephone and web browser callers in real time to a qualified representative. The system permits callers to schedule a conference if no representative comes on line. The system can initiates a conference if callers trust the system to hold their telephone numbers. The system delivers e-mails, faxes, and messages from telephone and web browser callers to a qualified representative through an electronic mail system that also transmits replies to message boxes that callers can access anonymously. The system can be configured to transmit replies to e-mails and faxes. Default systems assure that all calls are eventually handled by a representative. The system assures anonymity by concealing the electronic addresses from which users access the system. The system also permits telephone callers to mask their voices by either (1) distorting their speech, (2) dictating streamed messages, or (3) substituting a computer generated voice for their voice.

### CROSS-REFERENCE TO RELATED APPLICATIONS

This application claims the benefit of the filing date of U.S. Provisional Application No. 60/237,447, filed on Oct. 3, 2000 as attorney docket No. 1038.001.

### BACKGROUND OF THE INVENTION

1. Field of the Invention

The present invention relates to a computer-implemented method and system that connects anonymous workers (or other corporate constituents) to designated corporate representatives, and, more particularly, to a method and system for connecting anonymous workers to designated corporate representatives by telephone, web browser, e-mail, or fax.

2. Description of the Related Art

Companies pay billions of dollars each year in litigation costs, fines, and penalties when their efforts to comply with laws and regulations fail. Companies could avoid or minimize these costs if they had information about risks as the risks developed. Workers provide the best source of this information. Employees worry, however, about how their companies will respond to information about risk: will they shoot the messenger or the problem? This fear makes workers reluctant to come forward unless management provides them with a means of communicating anonymously.

Telephone “hotlines” staffed by outside operators currently provide the “state of the art” technology for facilitating these communications. Workers call the hotline, speak with a third party operator, and receive from the operator a case number and a time to call back. The operators then pass on the information to their corporate client. The company can give the operator information or follow-up questions for the anonymous employee in the event the worker calls back. The telephone operator acts as an intermediary in this way to assure anonymity to the employee.

This process—whereby a trusted third party acts as an intermediary—is slow, awkward, and labor-intensive. It is also risky because the company's response does not always get through to the employee. Operators sometimes forget to relay the company's reply, or garble the communication.

The Internet has addressed the need for anonymous communication tools in a number of contexts: match-makers, employment searches, and, more recently, the reporting of medical errors. For example, U.S. Pat. No. 5,884,272 (Walker, et al.) discloses a job search engine that conceals the identity of prospective employees and employers during the search process until both parties agree to communicate openly. That invention, however, unnecessarily inhibits communication because, among other things, (1) users can access the invention only via pre-configured computers (with data storage and processing capabilities) as opposed to via telephone or any Internet-ready appliance that has a browser, (2) it limits initial communications to the delayed exchange of pre-stored data, (3) it does not provide for the intelligent selection of call or message handlers, (4) it does not mask the voices of users who communicate by speech, and (5) it does not provide for interactive scheduling of conferences.

### SUMMARY OF THE INVENTION

Embodiments of the present invention permit workers to communicate anonymously with their employers through a variety of communications channels, upon demand, and without intervention of a third party, such as an operator. Depending on the particular implementation, embodiments of the present invention may provide some or all of the following:

Permit workers to access the system by telephone, web browser, e-mail, or fax. Access by telephone or web browser is referred to below as a “call.”

Permit workers to communicate by either speech or text at their option.

Permit workers to mask their voice if they chose to communicate orally.

Provide a system that permits workers to describe the nature of their call by responding to either voice, text, or graphical prompts.

Provide a system that permits workers to describe the nature of their call in natural language.

Provide a parsing system that discerns the nature of a worker's call, e-mail, or fax by analyzing (a) the caller's response to a voice, text, or graphical prompt, and/or (b) key words—whether delivered by voice or text.

Provide a sorting system that discerns whether a call is pertinent.

Connect callers to a qualified representative immediately if a call concerns a pertinent issue (e.g., as defined in advance by the employer).

Provide a routing system that selects the most-qualified corporate representative(s) to handle a call, e-mail, or fax based on (1) information provided by the worker and/or (2) other factors identified in advance by the corporation.

Provide a text-to-voice and voice-to-text translation system so that workers who access the system by web browser (and who communicate by typing words) can communicate with a qualified corporate representative at a remote location who has access to only a telephone.

Provide an appointment system that permits workers to select mutually convenient times to confer with a qualified corporate representative in the event a representative is not available when the worker first calls in.

Provide a message system that routes e-mails, faxes, and non-pertinent calls to the e-mail and/or voice-mail boxes of qualified representatives.

Provide a message system that permits workers to access the system to pick up replies from their company.

Provide a message system that ensures that the company responds to all employee messages within a pre-determined period of time (e.g., selected in advance by the employer) by re-routing employee messages to default representatives if a qualified representative does not reply in time.

In one embodiment, the present invention is a computer-implemented method for handling communications from one or more users for one or more subscribers, the method comprising the steps of (a) receiving a communication from a user; (b) querying the user for information regarding the communication; (c) receiving the information from the user in response to the querying; (d) determining whether the communication is pertinent or non-pertinent based on the information received from the user; (e) attempting to connect the user to a representative of a subscriber in real time, if the communication is determined to be pertinent; and (f) processing the communication for non-real-time handling by a representative of a subscriber, if the communication is determined to be non-pertinent.

In another embodiment, the present invention is a computer-based system for handling communications from one or more users for one or more subscribers, the system comprising a server configured to access one or more databases, wherein (a) the server is configured to receive a communication from a user; (b) the server is configured to query the user for information regarding the communication; (c) the server is configured to receive the information from the user in response to the querying; (d) the server is configured to determine whether the communication is pertinent or non-pertinent based on the information received from the user and information stored in at least one of the databases; (e) the server is configured to attempt to connect the user to a representative of a subscriber in real time, if the communication is determined to be pertinent; and (f) the server is configured to process the communication for non-real-time handling by a representative of a subscriber, if the communication is determined to be non-pertinent.

In yet another embodiment, the present invention is a process for a subscriber to handle communications from one or more users, the process comprising the steps of (1) engaging one or more representatives to handle the communications from the users; and (2) subscribing to a service provided by a computer-based system configured to (a) receive a communication from a user; (b) query the user for information regarding the communication; (c) receive the information from the user in response to the querying; (d) determine whether the communication is pertinent or non-pertinent based on the information received from the user; (e) attempt to connect the user to a representative of the subscriber in real time, if the communication is determined to be pertinent; and (f) process the communication for non-real-time handling by a representative of the subscriber, if the communication is determined to be non-pertinent.

### BRIEF DESCRIPTION OF THE DRAWINGS

Other aspects, features, and advantages of the present invention will become more fully apparent from the following detailed description, the appended claims, and the accompanying drawings. The term “subscriber” below denotes any entity that deploys or subscribes to the services provided by the invention to process communications from users. The term “user” denotes any person who accesses the system to communicate with a subscriber. The term “caller” refers to those “users” who access the system by either telephone or web browser.

FIG. 1 is a block diagram illustrating an embodiment of the present invention.

FIGS. 2A-2B illustrate the various means by which users can access the system, and depict an opening menu the system would present to telephone and web browser callers (in both speech and text form).

FIGS. 3A-E illustrate routines that process calls, mask the voices of callers, connect callers who present pertinent issues to qualified representatives of a subscriber or alternates if the most qualified is not available, provide a cascade of options if no representative answers a pertinent call, and handle follow-up calls.

FIGS. 4A-B show routines that connect callers to representatives for scheduled conferences, and that permit users who call about pertinent topics to schedule a conference if the system cannot immediately locate a qualified representative.

FIGS. 5A-F illustrate routines that take anonymous messages from callers, classify messages, deliver messages to a subscriber's most-qualified representative and assure timely handling by that representative or another representative, set up message boxes for callers who want a reply message from the subscriber, deliver replies from representatives to the appropriate message boxes, and enable callers to pick up reply messages anonymously.

FIG. 6 illustrates a routine that handles faxes and e-mails.

### DETAILED DESCRIPTION

The present invention provides a method and system for anonymous communication in a user/server/subscriber environment. The inventors contemplate that users will be workers, though they could be any class of persons that wants to report data anonymously to an enterprise. The system acts as an intelligent conduit. Subscribers may be companies, governments, regulatory bodies, or any entity that wants to solicit information from persons who (1) fear retribution and/or (2) do not want to get personally involved.

The system of the present invention improves the services provided by conventional operator-staffed telephone “hotlines.” Hotlines presently require users to call in by telephone. An operator answers the telephone, takes a message, and provides the caller with a number. The operator then summarizes the call and routes a report to the subscriber. The operator holds any reply message from the subscriber until someone (e.g., the original caller) calls back with the number, at which point the operator delivers the reply message.

The present invention is more accessible than conventional telephone operator systems. Users and subscribers can access the system through a variety of channels, including telephone, web browser, e-mail, and fax. The invention eliminates the operator system requirement of communicating through a chain of delayed voice messages (e.g., between telephone caller and operator and between operator and company representative) and the related requirement that users call back a second time to pick up replies.

Embodiments of the present invention employ parsing and sorting routines to (1) ascertain the nature of a call, (2) determine whether a telephone or web browser call is “pertinent” (e.g., as defined by subscribers), and (3) select a roster of representatives qualified to handle a call. The system connects telephone and web browser callers to a qualified representative for a conference if the call is “pertinent.” If no representative comes on line, then the system permits callers who present pertinent issues to schedule a future conference. The system may also be able to initiate such a future conference at the scheduled time, if callers trust the system to hold their telephone numbers. The system delivers e-mails, faxes, and messages from telephone and web browser callers to a qualified representative through an electronic mail system. The mail system transmits replies to message boxes that callers can access anonymously. It also transmits replies to e-mails and faxes if subscribers believe their users will trust the system to collect and hold the telephone numbers and e-mail addresses from which users access the system. Default systems assure that no call goes unclassified (pertinent vs. non-pertinent), and that all messages are eventually handled by a representative. The system assures anonymity by concealing from subscribers the electronic addresses from which users access the system. The system also permits telephone callers to mask their voices by either (1) distorting their speech, (2) dictating streamed messages, or (3) substituting computer-generated voices for their voices.

One embodiment of this invention contemplates that a trusted third party will host and maintain the server system. Some entities, however, may find that their constituents trust them to host and maintain the server system themselves.

One skilled in the art will appreciate that a server system may comprise any combination of hardware or software to perform the functions contemplated here, including different combinations of hardware or software to prompt users for information, sort data, parse text, mask the sound of a voice, substitute speech for streamed text and vice versa, forward telephone calls, display text, create message boxes, schedule meetings, and initiate scheduled telephone conferences or virtual meetings conducted by e-mail or through the display of text by other means.

One skilled in the art will also appreciate that various routines—and steps within routines—can be omitted or rearranged or adapted in various ways.

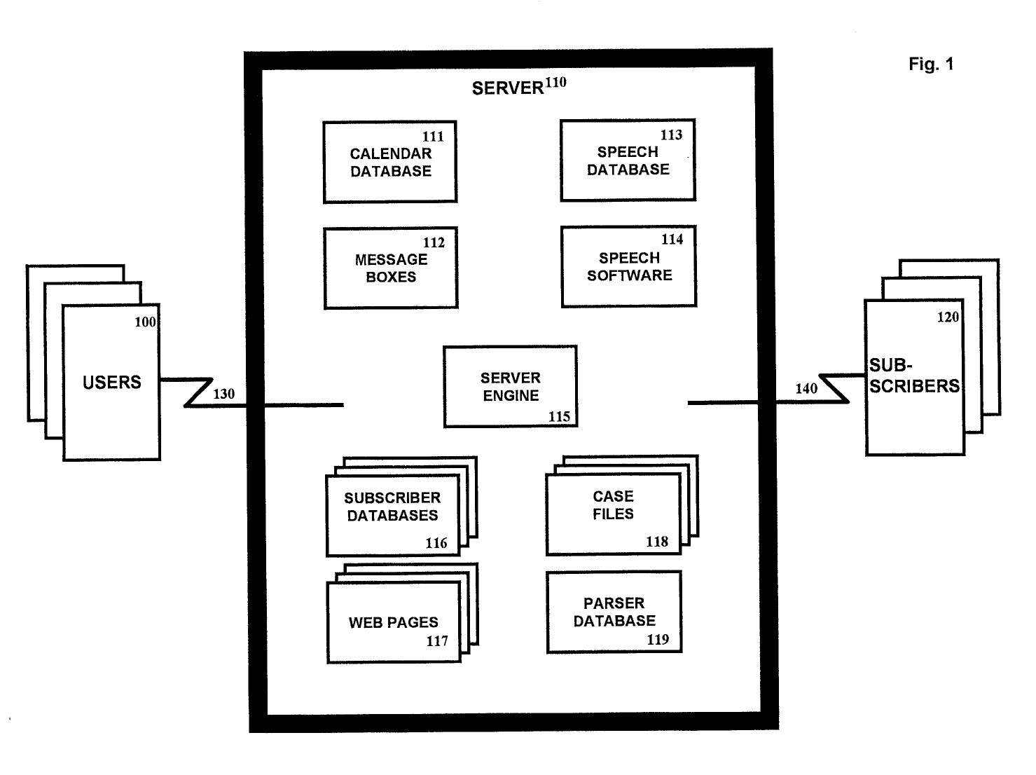

FIG. 1 is a block diagram illustrating an embodiment of the present invention. This embodiment supports anonymous, direct, and immediate communication by telephone and web browser, as well as delayed communication by e-mail and fax. The server system 110 includes a server engine 115, a calendar database 111, message boxes 112, a speech database 113, speech and dictation software 114, subscriber databases 116, web pages 117, case files 118, and a parser database 119. The communication devices under the control of users 100 and the communication devices under the control of subscribers 120 interact with the system by exchanging information via communications links 130 and 140, which may include transmissions over any suitable means, such as the Public Switched Telephone Network, the Internet, cable communications systems, local area networks, wide area networks, cellular networks, and/or electromagnetic radiation networks.

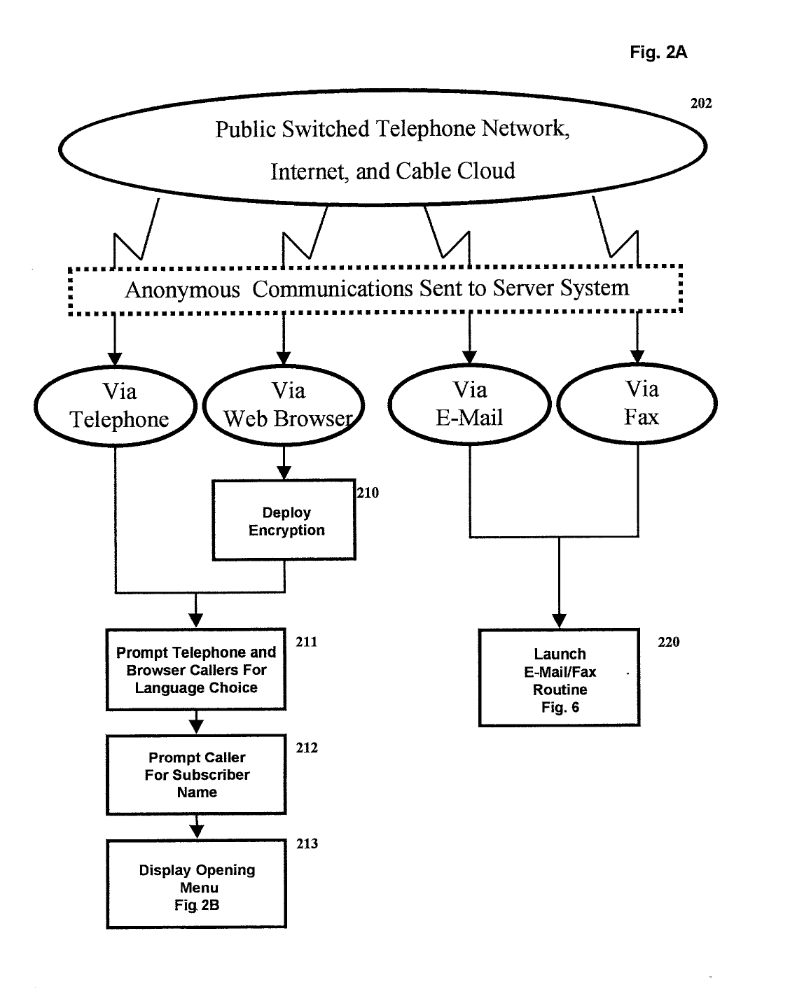

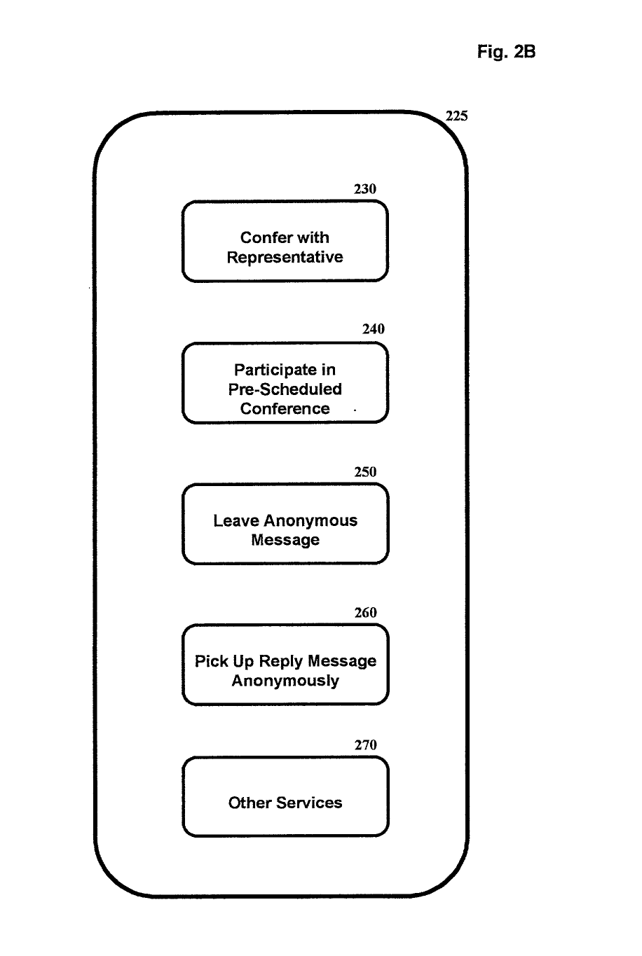

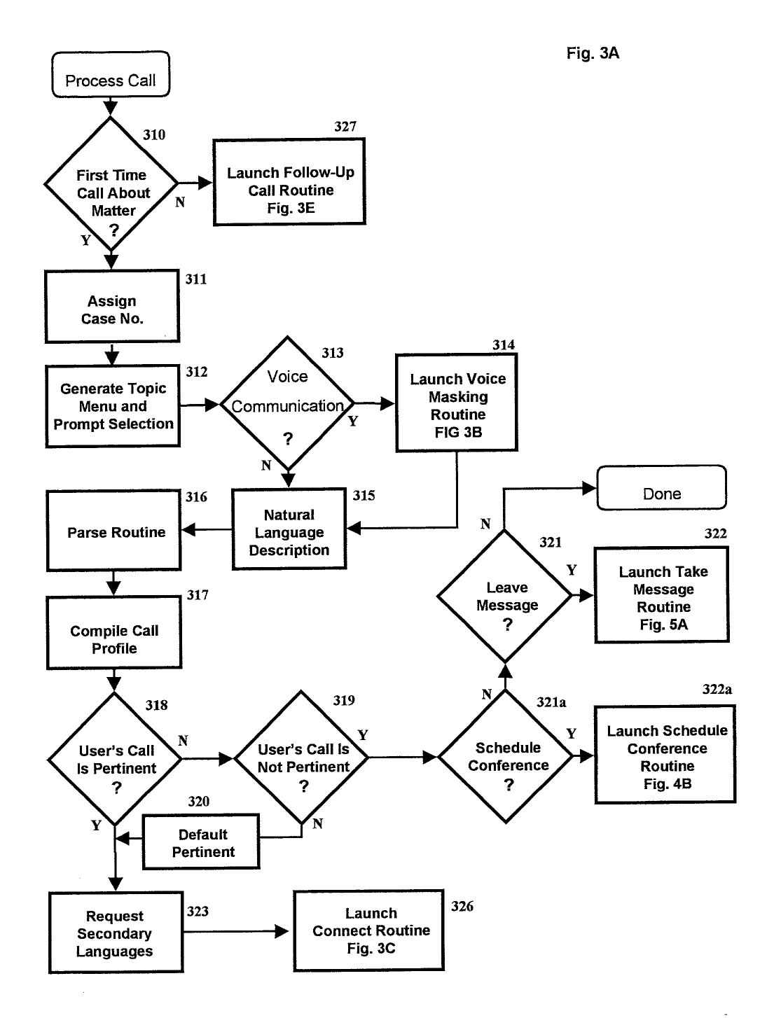

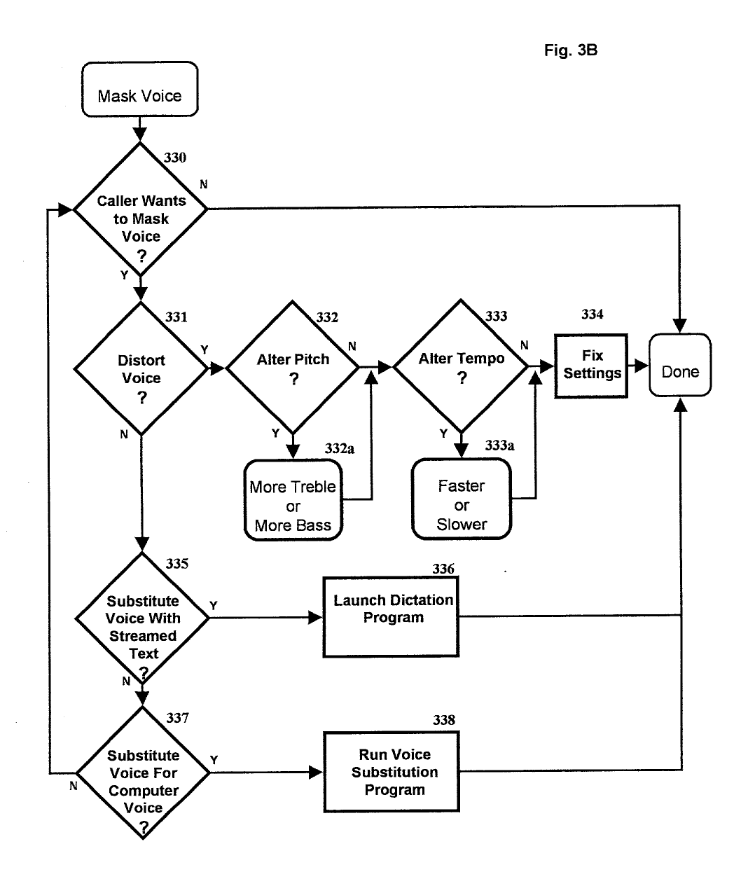

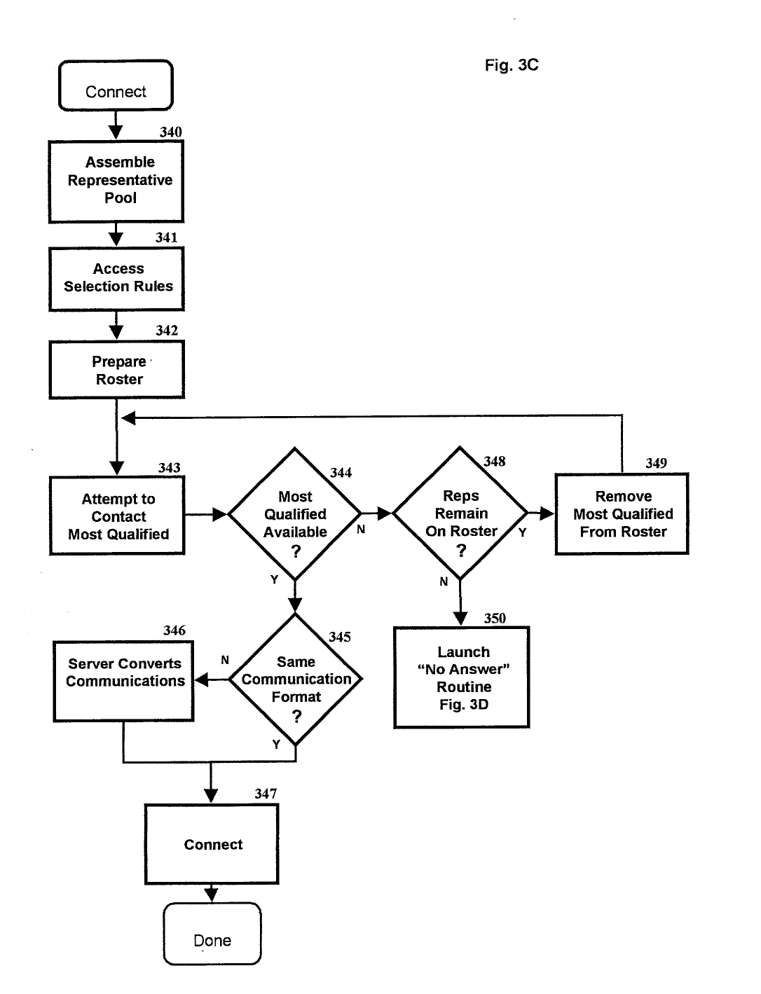

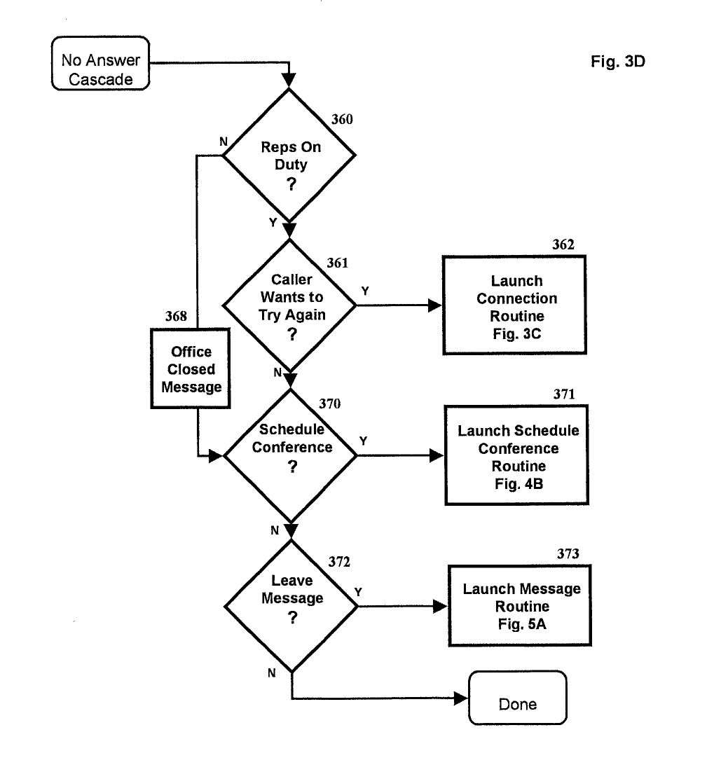

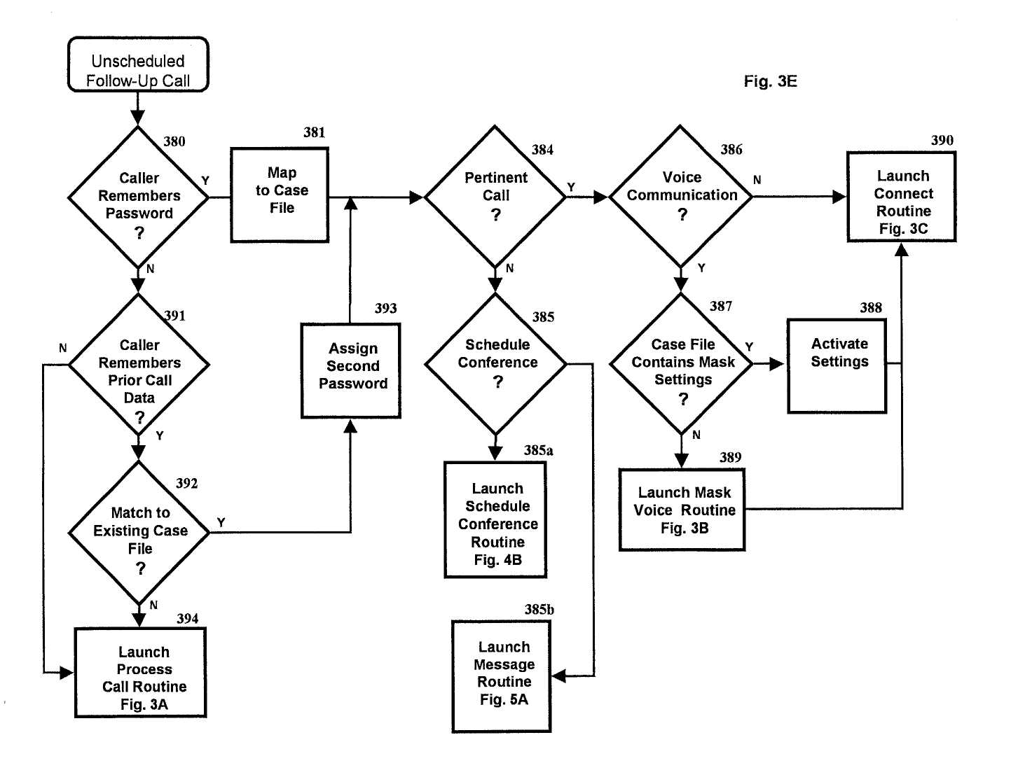

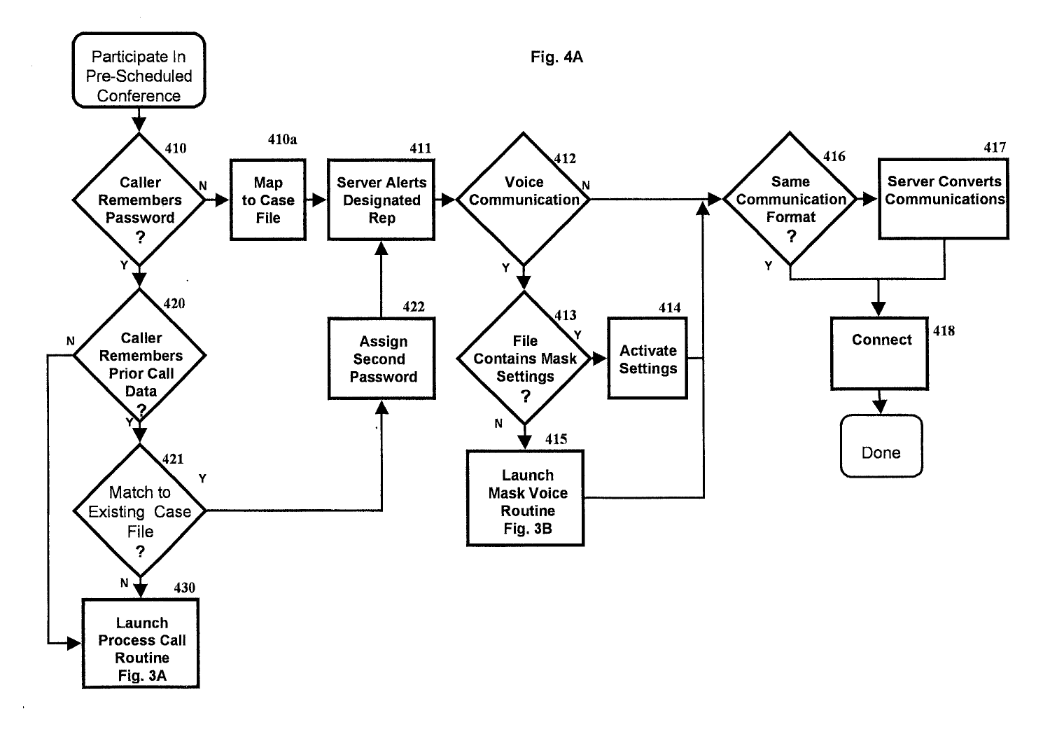

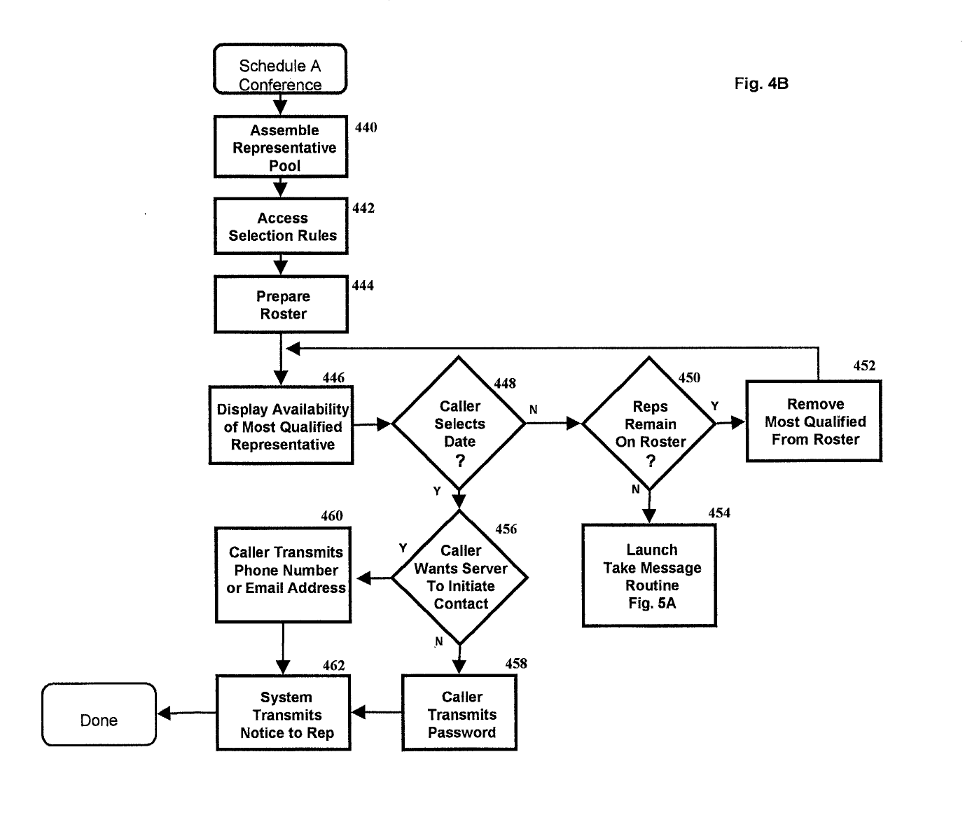

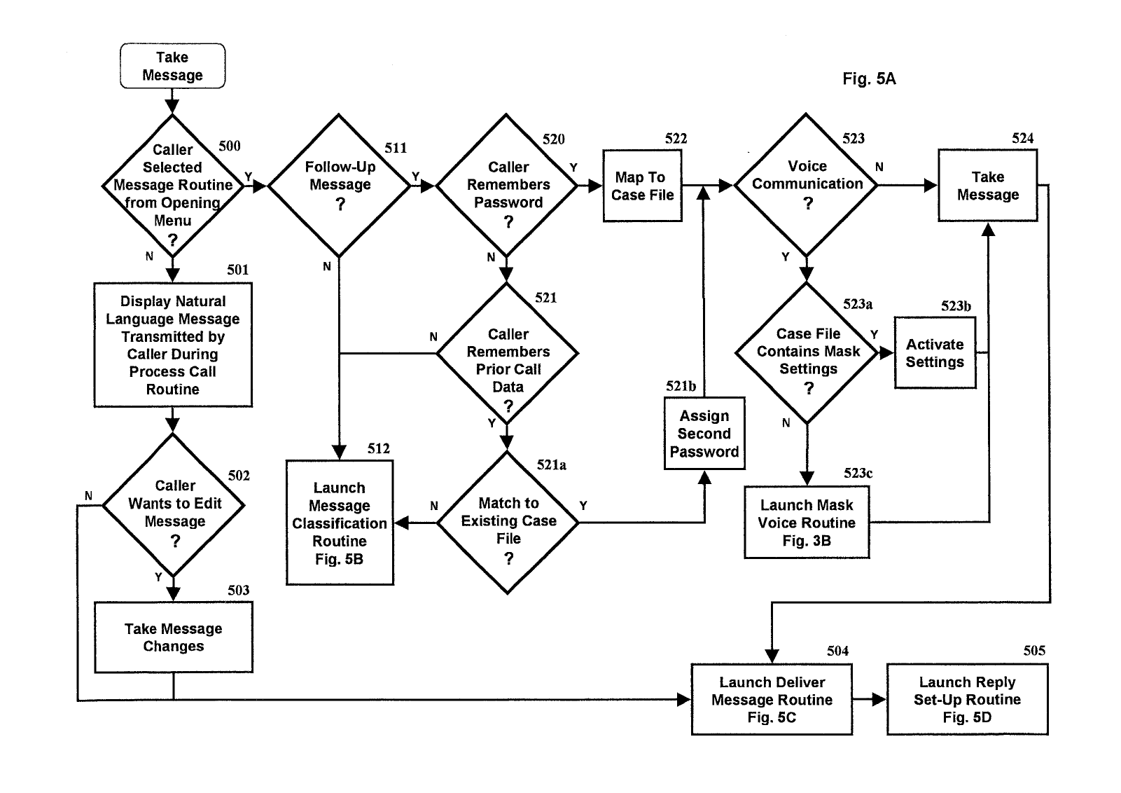

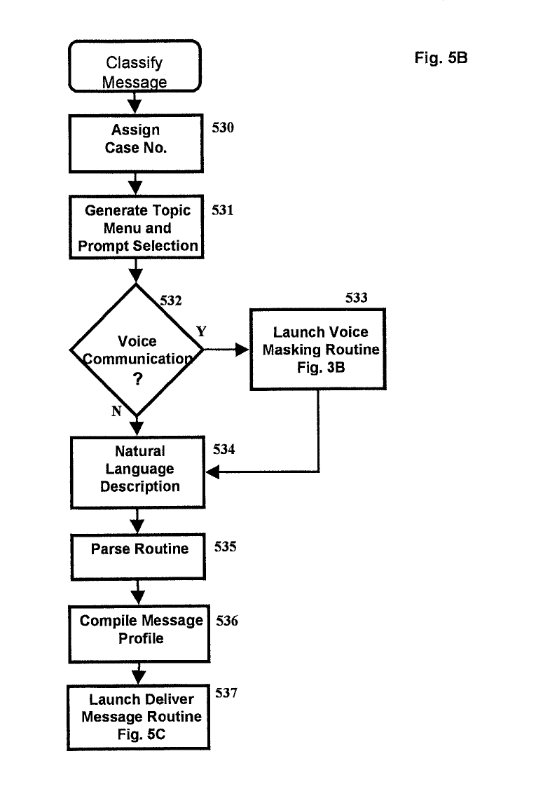

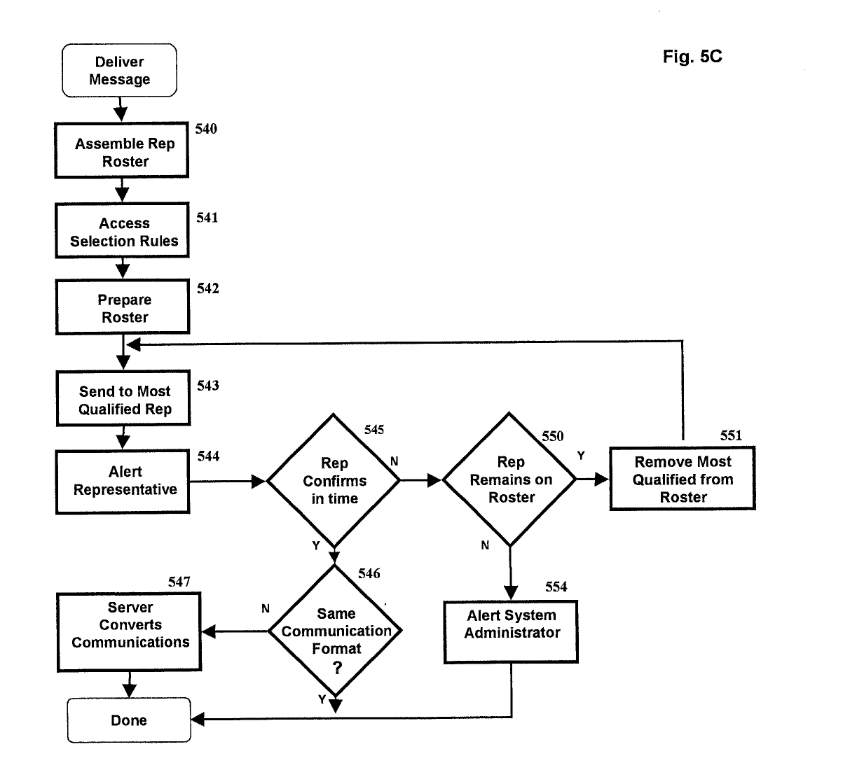

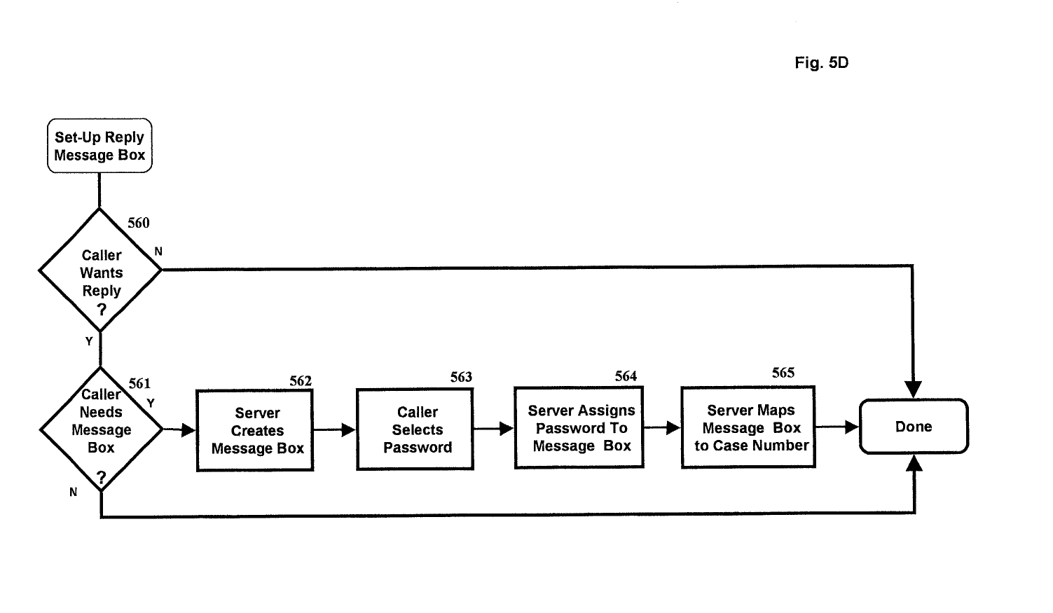

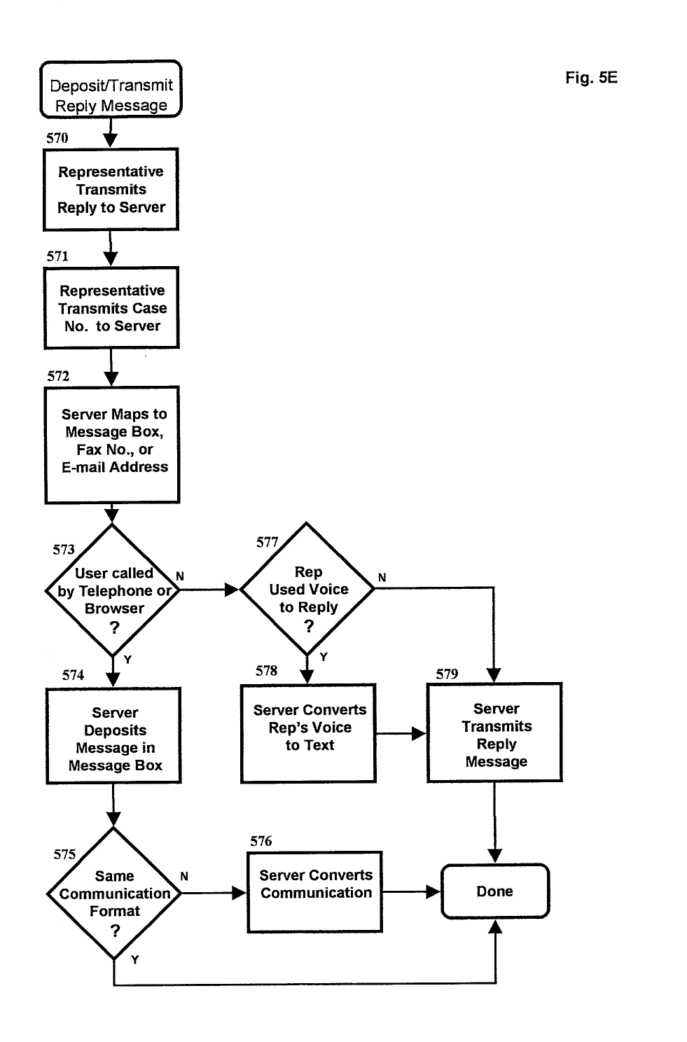

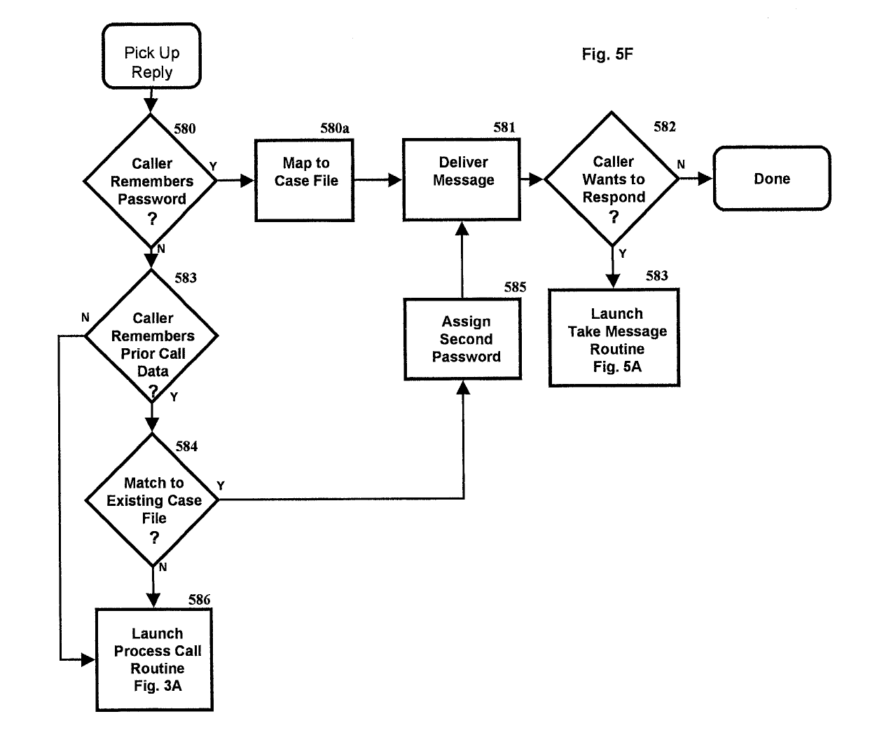

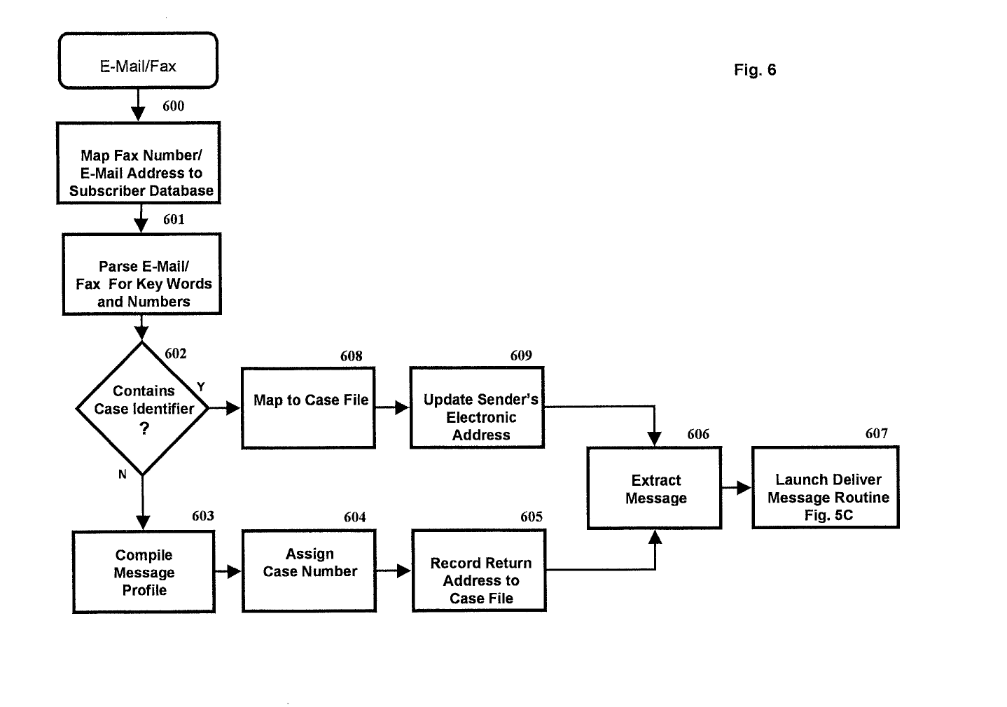

The server system 110 may receive communications from a variety of user communication devices 100, including telephones, pagers, web browsers, e-mail servers, and fax machines. In the case of telephone and web browser calls, the system responds with the prompts and menus depicted in FIGS. 2A-B. The callers' menu selections trigger the routines for handling telephone and web browser calls (see FIGS. 3A-E), conferences (see FIGS. 4A-B), and for leaving and picking up messages anonymously (see FIGS. 5A-F). The system automatically responds to e-mails and faxes by launching the routine depicted in FIG. 6.

FIG. 2A illustrates the various means 202 by which users can access the system. The server system preferably supports all available communications channels, such as the Public Switched Telephone Network, the Internet, and cable communication systems. Users may also transmit communications to the system through local and wide area networks.

The system deploys encryption software 210 when users access the system by web browser via the Internet. The system deploys the same greeting routine after that for both browser and telephone calls. The routine prompts users to identify their language of choice 211, and presents all future instructions in that language. It also prompts users to identify the subscriber (e.g., a particular company) they want to contact 212, so that the system can draw from the appropriate subscriber database as it launches the various routines that follow. The inventors use the term “the subscriber” below to refer to the subscriber selected by the user here. Opening menus for each subscriber are designed in advance and stored in the subscriber's database (FIG. 1, 116). The system completes the greeting routine by retrieving the opening menu from the subscriber's database and displaying it to the user 213.

In another embodiment of the invention, separate telephone lines and Uniform Resource Locator (URL) addresses or domain names are assigned to each subscriber. These telephone numbers and domain names are recorded in the subscriber databases. This adaptation obviates the need to prompt users for the name of the subscriber they want to contact. The system automatically identifies the subscriber by the telephone number or domain name the caller uses to access the system.

The system launches an e-mail/fax routine 220 when users transmit either e-mails or faxes to the system.

FIG. 2B depicts an opening menu 225 the system would present to telephone callers (in speech form) or to web browser callers (in text or speech form). Users can confer with a representative 230, participate in a scheduled conference 240, leave an anonymous message 250, pick up a reply message anonymously 260, or access other services 270.

FIG. 3A is a flow diagram of a routine which processes calls, e.g., when callers activate the routine from the opening menu as depicted in FIG. 2B, 230. The system first prompts users to indicate whether they are calling about their matter for the first time or whether instead they are following up on a prior call 310. The system assigns a case number to new calls 311 or launches a follow-up call routine 327 (see FIG. 3E). If the call concerns a new matter, the system accesses the subscriber's database, pulls up a discussion topic menu (which the subscriber designs in advance), presents the menu to the caller either through speech or displayed text, and prompts the caller to select one or more subjects 312. The system instructs users to rank the topics in order of importance if they select more than one. Subscribers with long topic lists can divide them into subject areas with headings, and display or verbally list a subject area's components when the user selects that heading.

The system permits callers either to supplement or to by-pass the selection of topics from the menu by speaking or typing a natural language description of why they want to contact the subscriber. (By natural language, the inventors mean that the caller may write or speak naturally without using key words or indicating the sequence of or distance between key words.) The system begins the natural language sub-routine by first ascertaining whether the caller is communicating by voice (either web browser or telephone) or text (web browser) 313. The system diverts callers who are communicating by speech to a routine which offers to mask their voice by a number of means 314 (see FIG. 3B). The system then prompts callers to describe (using natural language) why they want to contact the subscriber, either by speaking or entering text 315.

The system then performs a routine 316 in which the system accesses the subscriber's parser database for key words, phrases, numbers, and topic identifiers (FIG. 1, 119), compares them to the caller's topic selections and/or natural language description of the issue at hand, and designates the call as pertaining to one or more topics.

The system then compiles a call profile 317. The call profile at this point includes the case number, the time of the call, any natural language descriptions provided by the caller, and any topic(s) identified by the parsing routine (either from the natural language description or from the caller's topic menu selections). The system stores this data to a case file (FIG. 1, 118).

The system then classifies the call as either “pertinent,” “non-pertinent,” or “default pertinent” by comparing the topics in the call profile to a list of “pertinent” and “non-pertinent” topics selected in advance by the subscriber and stored in its database. In particular, the system classifies the call as “pertinent” 318, if any topic in the case file matches a topic on the subscriber's “pertinent” list. The system classifies the call as “non-pertinent” 319, if (1) any topic in the case file matches a topic on the subscriber's “non-pertinent” list, and (2) no topic in the case file matches a topic on the subscriber's “pertinent” list. The system classifies the call as “default pertinent” 320 (and treats it as a “pertinent” call), if no topic in the case file matches any topic on either the “pertinent” or “non-pertinent” lists. This feature reduces the systems failure rate by ensuring that all pertinent calls are immediately handled by a qualified representative even if the system fails to classify them affirmatively as “pertinent.”

If the call is “non-pertinent” 319, then the system asks whether the caller wants to schedule a conference 321a. If so, then the system launches a schedule conference routine 322 (see FIG. 4B). Otherwise, the system asks whether the caller wants to leave a message 321. If so, then the system launches a message taking routine 322 (see FIG. 5A). Otherwise, the call processing routine ends. As described in more detail below with reference to FIG. 5A, the message routine forwards anonymous messages to qualified representatives and provides callers with a message box through which they can receive replies anonymously.

The system continues the call processing routine to block 323 for both “pertinent” and “default pertinent” calls. In particular, the system prompts callers to indicate whether they speak languages other than their primary language 323. The system adds the information to the case file. A person skilled in the art will recognize that the system could collect additional data to refine the processing of calls.

The system concludes the routine for processing calls by launching a routine which selects the most-qualified representative to handle a call and connects the caller to that representative 326 (see FIG. 3C). In alternative implementations, the connect routine of FIG. 3C may be launched earlier in the processing (e.g. immediately upon the caller's selection of a topic from the menu 312) to shorten any delay experienced by the caller while the system attempts to contact a representative.

FIG. 3B illustrates the routine that masks the voice of callers who communicate by speech. The routine begins by prompting callers to indicate whether they want to (a) distort their voice 331, (b) substitute streamed text for their voice 335, or (c) substitute a computer-generated voice for their voice 337. The system prompts callers who choose to distort their voice to select from a menu. Callers can alter the pitch of their voice 332 by increasing the treble or the bass 332a, and/or the tempo 333 by making their voice faster or slower 333a. One skilled in the art will appreciate that there are other ways by which callers can alter their voices electronically. The system then fixes these settings for the duration of the call and stores these preferences in the case file 334. The system launches a dictation program 336, if callers want to communicate by streamed text 335. The system launches a voice substitution program 338, if callers want to substitute a computer-generated voice for their voice 337. The system accomplishes these tasks by accessing the speech database (FIG. 1, 113) and running speech software programs (FIG. 1, 114).

FIG. 3C illustrates the connect routine that connects callers who present pertinent (and default pertinent) issues to qualified representatives. The system begins by assembling data concerning the subscriber's pool of representatives 340 (or, in an alternative implementation discussed below, data concerning the pool of eligible representatives from two or more subscribers). The data includes the representatives'names, the topics for which they are responsible, their language fluency, the hours and days they are on duty, the calls they have previously handled (by case number), and other information selected in advance by the subscriber and stored in its database. The system then accesses the rules for selecting representatives 341. Again, the selection rules are set in advance by the subscriber and stored in its database. They determine the weight the system gives to (a) the call topic(s), (b) the languages spoken by the caller, (c) the representatives' areas of responsibility, (d) the time of the call, (e) the duty hours of the representatives, (f) whether the representative has handled a previous communication from the same user, and/or (g) other factors. The system then prepares a roster of qualified representatives 342, arranged from most qualified to least qualified.

The system then attempts to contact the most-qualified representative on the roster 343. The system accesses the subscriber's database to determine the means by which to contact the representative. These means may include multiple, redundant methods such as a page, a telephone call, an e-mail message, data displayed through web pages, or some other communication tool. If the currently selected representative does not respond to the call waiting message(s) within a time period specified in advance by the subscriber 344, then the representative is determined to be not available. If there are one or more representatives remaining on the roster 348, then the most qualified (but unavailable) representative is removed from the roster 349, and the processing returns to attempt to contact the most-qualified representative remaining on the roster 343. In one implementation, the system notifies the caller each time the system attempts to notify another representative so that the caller is informed of the current status of the processing. If there are no more representatives remaining on the roster 348, then the system launches a “no answer” routine 350 (see FIG. 3D).

If the currently selected representative is available 344, the system determines whether the caller and the representative are communicating via compatible formats 345. For example, some callers will communicate by streamed text. A representative responding from a public telephone currently could not view the text. The present invention addresses this need by automatically converting the caller's text into voice signals transmitted to the representative's phone (e.g., using a computer-based text-to-speech converter) and automatically converting the representatives voice signals into text displayed to the caller (e.g., using a computer-based speech-to-text converter) 346. The system also preferably provides representatives with remote speed dialing and conferencing capabilities.

The system then connects the caller to the representative 347. The system makes this connection in a manner which prevents the subscriber from “trapping and tracing” the caller's electronic address. For example, the only caller ID information that is made available to the representative is that of the server and not of the caller. This may be accomplished by having the server act as a bridge between two different calls: one between the caller and the system and the other between the system and the representative.

FIG. 3D illustrates the “no answer” routine that provides a cascade of options if no representative answers a pertinent or default pertinent call. If one or more representatives are on duty but have simply not responded 360, the system transmits a message to the caller to determine whether the caller wants to repeat the attempt to reach a representative 361. If so, then the system launches the connection routine 362 of FIG. 3C.

If the user does not want to try again to reach a representative in real time 361, then the system asks whether the caller wants to schedule a conference 370. Similarly, if there are no representatives currently on duty 360, then the system transmits an “office closed” message to the caller 368 before asking the caller wants to schedule a conference 370. In any case, if the caller wants to schedule a conference, then the system launches a routine that schedules conferences 371 (see FIG. 4B).

If the caller does not want to schedule a conference 370, then the system determines whether the caller wants to leave a message 372. If not, then processing terminates. Otherwise, the system launches a message taking routine 373 (see FIG. 5A).

FIG. 3E demonstrates a routine that handles follow-up calls. The routine begins by prompting callers to transmit the password from their prior call by speech or keyboard 380. If the caller remembers the password, then the system maps the password to the case file 381. The system then determines from the case file how the prior call was classified (i.e., “pertinent,” “non-pertinent,” or “default pertinent”) 382. If the prior call was classified as “pertinent” or “default-pertinent” 384, then the system determines if communication is by text or speech 386. If the communication is by speech, then the system determines whether any voice masking instructions are stored in the case file from the previous call from that same caller 387. If so, then the system activates those same voice masking settings 388 and then launches the connect routine 390 of FIG. 3C. If the case file does not already contain voice masking instructions 387, then the system launches the voice masking routine 389 of FIG. 3B to allow the caller to mask his or her voice, before continuing to launch the connect routine 390.

If the prior call was classified as “non-pertinent” 384, then the system determines whether the callers wants to schedule a conference 385. The system launches the routine that schedules conferences if the callers wants to 385a (see FIG. 4B). Otherwise, the system launches the message taking routine 385b of FIG. 5A.

If callers do not remember their password 380, then the system attempts to identify such callers not by their knowledge of a password but by their knowledge of other case-specific data. This authentication process is based on the premise that callers who forget their passwords will nonetheless typically remember data that they previously provided to the system and which only they (or someone acting on their behalf) will know. The system authenticates these callers by prompting them for this data 391 and matching their responses to data stored in the case files 392. This information could include the discussion topic, the date the caller first contacted the system, key words that the caller used in the prior call, or other data. Subscribers can customize this alternative identification system to permit a margin of error. For example, callers might remember their discussion topic and key words but not the precise date on which they first contacted the system. Subscribers can instruct the system nonetheless to “match” a caller in this circumstance if the caller remembered the week or month during which he or she first contacted the system. If the data entered by the caller matches data in a case file 392, then the system prompts the caller to select a new password 393 and continues the processing from the determination of whether the call is a pertinent call 384, as described above.

If the user does not remember any other data 391 or the data does not match an existing case file 392, then the system launches the call processing routine 394 of FIG. 3A (beginning with the assignment of a new case number 311).

FIG. 4A illustrates the routine that connects callers to representatives for scheduled conferences. Callers activate the routine from the opening menu as depicted in FIG. 2B, 240. In the present embodiment of the invention, the system begins by prompting callers for their password 410. If the caller remembers his or her password 410, then the system maps the password to the case file 410a and alerts the designated representative 411. Before connecting the caller to the designated representative 416-418, the system performs processing steps 412-415, which are analogous to processing steps 386-389 of FIG 3E, to mask the caller's voice if appropriate. Note that steps 416-418 are analogous to 345-347 of FIG. 3C.

If the caller does not remember his or her password 410, then the system performs processing steps 420-422, which are analogous to processing steps 391-393 of FIG. 3E, to determine whether the caller remembers other data that can be used to identify the case file. If a match between the caller's responses to data stored in the case files cannot be made 421, then the system launches the call processing routine 430 of FIG. 3A (beginning with the assignment of a new case number 311). Otherwise, after assigning the caller a new password 422, the system continues the processing by alerting the designated representative 411, as described above.

FIG. 4B illustrates a routine that permits users to schedule a conference with a qualified representative. The system performs steps 440-444, which are analogous to steps 340-342 of FIG. 3C, to assemble a roster of qualified representatives arranged from most qualified to least qualified. The system then displays the dates and times for which the most qualified representative is available 446. If the caller selects one of the proposed dates 448, the system prompts her to indicate whether she wants to initiate the call or whether she wants (trusts) the system to take her electronic address in order to initiate the call 456. If the caller wants to initiate the call 456, then the system asks her to assign a password for the conference 4458, which she later uses to identify herself when re-contacting the system. If the caller wants the system to initiate the conference call 456, then the system asks her for her telephone number or e-mail address 460.

The system performs steps 450-452, which are analogous to steps 348-349 of FIG. 3C, to present alternative conference dates and times to the caller in the event (a) the most qualified representative's office hours are not convenient for the caller, and (b) there are additional representatives on the roster. The system launches the message routine of FIG. 5A in the event that none of the available conference dates are convenient to the caller 350.

Subscribers may vary the “office hours” of their representatives depending on the caller's discussion topic, including whether the call has been classified as “pertinent” or “non-pertinent.” For example, a subscriber may make more representatives available over a longer workday to field calls on particular topics.

FIG. 5A illustrates a routine that takes anonymous messages from callers. Callers will leave anonymous messages under at least two circumstances: (1) they attempted to confer “live” with a representative but the system classified their call as “non-pertinent” and referred them to the message routine, or (2) they contacted the system for the purpose of leaving a message (e.g., not wanting direct contact with a representative) by activating the routine from opening menu 225 of FIG. 2B, 250. If the caller did not select the message taking routine from the opening menu 500, then the system displays the topic selections and/or natural language message the caller has already provided to the system 501, prompts the caller for any changes 502-503, and launches the message delivery routine 504 (see FIG. 5C) and the reply set-up routine 505 (see FIG. 5D).

If callers select the message taking routine from the opening menu 500, then the system prompts them to indicate whether they are calling to leave a follow-up message 511. If not, then the system launches a message classification routine 512 (see FIG. 5B). Otherwise, the system prompts callers for their password 520 so that it can match them to a case file 522. If a caller does not remember her password, then the system prompts her for other data 521 and attempts to match that data with data in an existing case file. The processing of steps 520, 521, 521a, and 521b is analogous to the processing of steps 380, 391, 392, and 393 of FIG. 3E. If the system cannot match a caller to an existing case file, then the system launches the message classification routine 512. If the system can match the caller to an existing case file 521a or 522, then the system masks the caller's voice if applicable 523-523c, takes a natural language message in either text or speech form 524, and launches the message delivery and reply set-up routines 504-505. The processing of steps 523, 523a, 523b, and 523c is analogous to the processing of steps 386-389 of FIG. 3E.

FIG. 5B demonstrates the routine that classifies messages. The routine assigns a case number 530 and performs steps 531-536, which are analogous to steps 312-317 of FIG. 3A, to enable the system to take a natural language message from the caller and to compile a message profile. The system then activates the message delivery routine 537 (see FIG. 5C).

FIG. 5C illustrates the routine that delivers messages to a subscriber's most-qualified representative and assures timely handling by that representative or another representative. The system performs steps 540-542, which are analogous to steps 340-342 of FIG. 3C, to assemble a roster of qualified representatives arranged from most qualified to least qualified. The system then transmits the user's message to the most-qualified representative by multiple and redundant means including telephone, e-mail, pager, and fax 543. The system simultaneously alerts the currently selected representative that he or she has received a message, again by multiple and redundant means including pager, e-mail, and voice mail 544. Subscribers can customize this alert feature so that some but not all of the representatives to whom the system sends the message receive the alert notice. This spares representatives who have elected to receive copies of messages for informational purposes only from being interrupted by the alert messages.

If the currently selected representative confirms receipt and handling of a message within a period of time set in advance by the subscriber 545, then the system converts the message as needed 546-547. For example, the system could translate a text message into speech for a representative who called the system from a pay phone at an airport. The processing of steps 546-547 is analogous to the processing of steps 345-346 of FIG. 3C.

If the currently selected representative does not confirm receipt and handling of a message within the specified period of time 545, then, if there are one or more representatives remaining on the roster 550, the system removes that representative from the roster 551 and returns the processing to step 543 to send the caller's message to the most-qualified representative remaining on the roster. If the roster is empty 550 (indicating that no representative has responded within the specified period of time), then the system alerts the system administrator about that situation 554.

FIG. 5D illustrates the routine that sets up message boxes for callers who want a reply message from the subscriber. The system prompts callers to indicate whether they want a reply 560 and whether they need to set up a message box 561 (repeat callers may already have one). If so, then the system creates a message box for the caller 562, solicits a password from the caller 563, assigns the password to the message box 564, and maps the message box and password to the case number 565. This last step enables the system to associate the message box with the caller and to deliver the subscriber's reply to the caller's message box.

FIG. 5E illustrates the routine that deposits replies from representatives to the appropriate message boxes of callers, or transmits the replies to the appropriate fax machine or e-mail box of users who access the system by those means. The routine begins with the representative transmitting the reply 570 and the corresponding case number 571 to the server. The server then maps the reply to the corresponding message box, fax number, or e-mail address 572. If the user contacted the system by telephone or web browser 573, then the server deposits the representative's reply message into the user's message box 574 for subsequent access by the user. If the representative's reply message is in a different communication format from the user 575, then the system converts the representative's reply message (e.g., speech to text or text to speech) as appropriate 576. The processing of steps 575-576 is analogous to the processing of steps 345-346 of FIG. 3C.

If the user did not contact the system by telephone or web browser 573 (e.g., the user contacted the system by fax or e-mail), then the system determines whether the representative's reply message is a voice message 577. If not, then the system transmits the reply message to the user by the appropriate means (e.g., fax or e-mail) 579. If the reply message is a voice message, then the system converts the voice message to text 578 before transmitting the reply message to the user 579. In order to send a reply message via fax or e-mail, the system must have recorded the electronic address (fax number or e-mail address) from which the original user message was sent. Persons skilled in the art will appreciate that some users may not trust the system to hold this data in confidence, and will therefore not use the system. As such, users are preferably given the option as to whether to authorize the system to capture and hold return addresses for the later transmission of replies. As is noted below in FIG. 6, if subscribers want the reply function, then the system captures the electronic addresses of users as they send faxes and e-mails to the system, records the electronic return addresses to the case files, and then uses this data to send any replies back to the users.

FIG. 5F demonstrates a routine that enables callers to pick up reply messages anonymously. Callers activate this routine from the opening menu depicted in FIG. 2A, 260. The system prompts callers for their password 580 or other data 583 to match the caller with an existing message box. If the system cannot match the caller to an existing message box, then the system launches the call processing routine 512 of FIG. 3A. The processing of steps 580, 580a, 583, 584, and 585 is analogous to the processing of steps 380, 381, 391, 392, and 393 of FIG. 3E. If the system can match the caller to an existing message box, then (after assigning a new password to the caller 585 if necessary), the system delivers the subscriber's reply message in the caller's message box to the caller either in voice or text format 581. In an alternative implementation, if the caller does not remember his or her password, the system may prevent access to message boxes, but allow scheduled conferences and/or real-time connection to representatives to proceed. If the callers wants to respond to the subscriber's reply message 582, then the system launches the message taking routine 583 of FIG. 5A to take the caller's response message.

FIG. 6 illustrates the routine that handles faxes and e-mails. In a preferred embodiment of the invention, the system assigns and provides a unique fax number and e-mail address to each subscriber and stores this data in the subscriber database FIG. 1, 116. The subscribers then disseminate their fax numbers/e-mail addresses to the constituents (e.g., employees) from whom they solicit anonymous information.

As communications come into the system over the fax lines or through the e-mail addresses, the system identifies the subscriber to which to route the fax or e-mail by mapping the fax number or e-mail address used to the subscriber database 600. The system then parses faxes and e-mails for key words and numbers 601 for the purpose of (A) assigning a topic to the message if possible, (B) ascertaining the sender's language, and (C) determining whether the user included a case identifier 602 (such as a case number or password).

If the message does not contain a case identifier 602, then the system compiles and stores the parsed data in a case file 603 and assigns a case number to the file 604. The system also records the sender's electronic return address in the case file 605, if the parties have enabled the reply message function. If the message does contain a case identifier 602, then the system maps the message to the case file 608 and (optionally) updates the user's electronic address 609 if a new one is used.

In either case, the system then extracts the text of the communication from the sender's fax or e-mail 606 and delivers only the communication itself to an appropriate representative 607. This prevents the representative from seeing either the sender's telephone number printed across the top of a fax or the sender's e-mail address in the “From” box of an e-mail template. The system then delivers the communication to the representative by deploying the message delivery routine of FIG. 5C.

As was noted above, at the option of users and subscribers, the system enables representatives to reply to faxes and e-mails through the transmission routine of FIG. 5E.

In a preferred embodiment of the invention, subscribers activate this feature, and, when transmitting a reply, the system inserts a case identifier in the “re” line of the reply fax or e-mail. This permits users who wish to engage in a series of communications with representatives to refer to the case identifier in their faxes and e-mails. As the system receives these follow-up communications by fax/e-mail, the parsing function will search for the case identifier in addition to other data.

In the implementations described above, the server treats each subscriber independently, such that a user who contacts the system for a particular subscriber is handled by the system independent of any other subscribers to the services provided by the system as well as independent of any other callers who access the system at the same time for those other subscribers. For example, the roster of representatives generated for a particular call correspond to only representatives employed by one subscriber. Alternative implementations are also possible. For example, in some implementations, the different representatives included in the pool of representatives from which the roster of qualified representatives is generated may correspond to two or more different subscribers to the services provided by the system. In that case, the relative qualifications of the different representatives used to arrange the representatives in the roster by their relative qualifications may reflect their own personal capabilities and/or the capabilities of the particular subscribers for whom they work.

Also in the implementations described above, the server activates some routines for users who access the system by traditional web browser, and other routines for users who access the system by e-mail. Alternative implementations are also possible for users who access the system by near real time or by real time interactive e-mail messaging. In those implementations, the term web browser in the descriptions above and the claims below refers both to traditional web browsers and e-mail.

The present invention may be implemented as circuit-based processes, including possible implementation on a single integrated circuit. As would be apparent to one skilled in the art, various functions of circuit elements may also be implemented as processing steps in a software program. Such software may be employed in, for example, a digital signal processor, micro-controller, or general-purpose computer.

The present invention can be embodied in the form of methods and apparatuses for practicing those methods. The present invention can also be embodied in the form of program code embodied in tangible media, such as floppy diskettes, CD-ROMs, hard drives, or any other machine-readable storage medium, wherein, when the program code is loaded into and executed by a machine, such as a computer, the machine becomes an apparatus for practicing the invention. The present invention can also be embodied in the form of program code, for example, whether stored in a storage medium, loaded into and/or executed by a machine, or transmitted over some transmission medium or carrier, such as over electrical wiring or cabling, through fiber optics, or via electromagnetic radiation, wherein, when the program code is loaded into and executed by a machine, such as a computer, the machine becomes an apparatus for practicing the invention. When implemented on a general-purpose processor, the program code segments combine with the processor to provide a unique device that operates analogously to specific logic circuits.

It will be further understood that various changes in the details, materials, and arrangements of the parts which have been described and illustrated in order to explain the nature of this invention may be made by those skilled in the art without departing from the scope of the invention as expressed in the following claims.

What is claimed is:

1. A computer-implemented method for handling communications from one or more users for one or more subscribers, the method comprising the steps of:
(a) receiving a communication from a user;
(b) querying the user for information regarding the communication;
(c) receiving the information from the user in response to the querying;
(d) determining whether the communication is pertinent or non-pertinent based on the information received from the user;
(e) attempting to connect the user to a representative of a subscriber in real time, if the communication is determined to be pertinent; and
(f) processing the communication for non-real-time handling by a representative of a subscriber, if the communication is determined to be non-pertinent.

2. The invention of claim 1, wherein identity of the user is unknown to the representative and the subscriber throughout steps (a)-(f).

3. The invention of claim 1, wherein the communication may be received from the user via any of a to telephone call, a web access, a fax, and an e-mail message, wherein, if the communication is received via a fax or an e-mail message, then the communication is processed for non-real-time handling by the representative.

4. The invention of claim 3, wherein step (f) comprises the step of automatically storing a return address if the communication is received via a fax or an e-mail message for use in automatically transmitting a reply from the representative to the user, wherein the return address is revealed to neither the representative nor the subscriber.

5. The invention of claim 1, wherein steps (b)-(d) are implemented using natural-language processing.

6. The invention of claim 5, wherein step (d) comprises the steps of:
(1) parsing the information from the user into one or more parsed terms;
(2) comparing the one or more parsed terms to a first list of one or more pertinent terms and determining that the communication is pertinent if at least one parsed term is in the first list;
(3) otherwise, comparing the one or more parsed terms to a second list of one or more non-pertinent terms and determining that the communication is non-pertinent if at least one parsed term is in the second list; and
(4) otherwise, determining that the communication is pertinent.

7. The invention of claim 1, wherein step (e) comprises the steps of:
(1) generating, based on the information from the user, a roster of one or more qualified representatives of at least one subscriber, wherein the qualified representatives are arranged from most qualified to least qualified based on (i) the information from the user and (ii) one or more characteristics of the qualified representatives; and
(2) attempting to connect the user in real time to a qualified representative on the roster starting from the most qualified and sequentially progressing towards the least qualified until either a qualified representative is available to handle the communication from the user in real time or none of the qualified representatives on the roster are available to handle the communication from the user in real time.

8. The invention of claim 7, wherein the roster of qualified representatives is generated from a pool of representatives based on a subject matter of the user's communication and expertise of the representatives.

9. The invention of claim 7, wherein the roster of qualified representatives is generated from a pool of representatives based on language proficiency information for the user and each representative.

10. The invention of claim 7, wherein the roster of qualified representatives is generated from a pool of representatives based on timing of the communication from the user and a schedule for each representative.

11. The invention of claim 7, wherein the roster is generated based on whether a representative has handled a previous communication from the same user.

12. The invention of claim 7, wherein step (e)(2) comprises the step of transmitting two or more different types of messages in real time to a currently selected representative in an attempt to alert the representative that a user is waiting.

13. The invention of claim 7, wherein each attempt to connect the user to a qualified representative is terminated, if that representative does not respond to the attempt within a specified duration.

14. The invention of claim 7, wherein step (e)(1) comprises the step of generating a roster of two or more qualified representatives corresponding to two or more different subscribers.

15. The invention of claim 1, wherein step (e) comprises the steps of:
(1) determining whether the user and the representative will communicate using different formats; and
(2) if so, then applying at least one of computer-based speech-to-text processing and computer-based text-to-speech processing to convert one or more messages transmitted between the user and the representative.

16. The invention of claim 1, comprising the step of enabling the user to leave a message for non-real-time handling by the representative, if step (e) fails to connect the user to any representative or if the communication is non-pertinent.

17. The invention of claim 16, comprising the steps of:
enabling the representative to leave, in a message box assigned to the user, a reply to the message; and
enabling the user to retrieve the reply from the user's message box.

18. The invention of claim 1, comprising the step of enabling the user to schedule a conference with a representative, if step (e) fails to connect the user to any representative or if the communication is non-pertinent.

19. The invention of claim 18, comprising the step of allowing the user to choose from a list of one or more available times for the conference based on availability of one or more representatives.

20. The invention of claim 1, wherein the communication from the user is by voice and further comprising the step of masking the user's voice.

21. The invention of claim 20, wherein the user's voice is masked by distorting audio signals corresponding to the voice.

22. The invention of claim 20, wherein the user's voice is masked by applying speech-to-text processing to convert the user's voice into text.

23. The invention of claim 22, further comprising the step of applying text-to-speech processing to convert the text into a computer-generated voice that is transmitted to the representative.

24. The invention of claim 1, further comprising the steps of:
assigning the user a password for a subsequent communication regarding the communication; and
allowing the subsequent communication, if the user provides either (i) the password or (ii) other identifying information related to the communication.

25. A machine-readable medium, having encoded thereon program code, wherein, when the program code is executed by a machine, the machine implements a method for handling communications from one or more users for one or more subscribers, the method comprising the steps of:
(a) receiving a communication from a user;
(b) querying the user for information regarding the communication;
(c) receiving the information from the user in response to the querying;
(d) determining whether the communication is pertinent or non-pertinent based on the information received from the user;
(e) attempting to connect the user to a representative of a subscriber in real time, if the communication is determined to be pertinent; and
(f) processing the communication for non-real-time handling by a representative of a subscriber, if the communication is determined to be non-pertinent.

26. A computer-based system for handling communications from one or more users for one or more subscribers, the system comprising a server configured to access one or more databases, wherein:
(a) the server is configured to receive a communication from a user;
(b) the server is configured to query the user for information regarding the communication;
(c) the server is configured to receive the information from the user in response to the querying;
(d) the server is configured to determine whether the communication is pertinent or non-pertinent based on the information received from the user and information stored in at least one of the databases;
(e) the server is configured to attempt to connect the user to a representative of a subscriber in real time, if the communication is determined to be pertinent; and
(f) the server is configured to process the communication for non-real-time handling by a representative of a subscriber, if the communication is determined to be non-pertinent.

27. A process for a subscriber to handle communications from one or more users, the process comprising the steps of:
(1) engaging one or more representatives to handle the communications from the users; and
(2) subscribing to a service provided by a computer-based system configured to:
(a) receive a communication from a user;
(b) query the user for information regarding the communication;
(c) receive the information from the user in response to the querying;
(d) determine whether the communication is pertinent or non-pertinent based on the information received from the user;
(e) attempt to connect the user to a representative of the subscriber in real time, if the communication is determined to be pertinent; and
(f) process the communication for non-real-time handling by a representative of the subscriber, if the communication is determined to be non-pertinent.
